(19) United States
(12) Patent Application Publication
(10) Pub. No.: US 2014/0047905 A1
(43) Pub. Date: Feb. 20, 2014

(54) Electrospray Emitter Assembly

(71) Applicants: Michael J. Tomany, North Grosvenordale, CT (US); Paul Rainville, Princeton, MA (US); James P. Murphy, Franklin, MA (US)

(72) Inventors: Michael J. Tomany, North Grosvenordale, CT (US); Paul Rainville, Princeton, MA (US); James P. Murphy, Franklin, MA (US)

(73) Assignee: WATERS TECHNOLOGIES CORPORATION, Milford, MA (US)

(21) Appl. No.: 14/004,240

(22) PCT Filed: Mar. 5, 2012
(86) PCT No.: PCT/US12/27722

§ 371 Date: Oct. 30, 2013

Related U.S. Application Data
(60) Provisional application No. 61/451,260, filed on Mar. 10, 2011.

(51) Int. Cl. G01N 30/72; B05B 5/025

(52) U.S. Cl. CPC G01N 30/72; B05B 5/025
USPC 73/61.52; 239/690; 29/592.1

(57) ABSTRACT

An electrospray emitter assembly (4) for an interface device (1) used to connect the output of a liquid chromatograph to the inlet of an electrospray ion source of a mass spectrometer (10). The device (1) incorporates an electrospray emitter assembly (4) that includes an emitter needle (40), a sheath (6) and a housing (5) with an attachment means in the form of a flange (55) for attachment to a mass spectrometer (10). The sheath (6) is arranged to shield the electrospray emitter needle (40) when the assembly is not attached to a mass spectrometer (10). The assembly (4) is operable to move the sheath (6) thereby to reveal, in use, the electrospray emitter needle (40) when the assembly (4) is attached to the mass spectrometer (10).

### CROSS REFERENCE TO RELATED APPLICATIONS

This application claims priority to U.S. Provisional Application No. 61/451,260, filed Mar. 10, 2011. The entire contents of U.S. Provisional Application No. 61/451,260 are incorporated herein by reference.

### TECHNICAL FIELD

This disclosure relates to electrospray emitter assemblies and more specifically although not exclusively to small scale electrospray emitter assemblies.

### BACKGROUND

Mass spectrometers can be used to analyze complex samples. It is frequently necessary to separate complex samples before analyzing them. This is usually done using a liquid chromatography system.

In recent times, liquid chromatography systems have developed into smaller and smaller volume systems. Due to this, the connections between the liquid chromatography systems and the mass spectrometer ion sources have also developed into smaller and smaller scale apparatus.

Typical connections between liquid chromatography devices include a capillary as the electrospray emitter tip that a user inserts manually into a housing, which can then be attached to the mass spectrometer. However, these capillaries are delicate and due to the small sizes of the capillaries they can also be extremely difficult to fit, which can be time consuming. Any errors in the positioning of the capillary may lead to poor results from the analysis for example due to memory effects from small pockets of sample held in voids in the connections.

These capillaries can get clogged up with salts or, in some cases they can leave contaminants on the walls leading to memory effects, due to the types of samples being run. When the capillary is being replaced, this leads to instrument down time, which is particularly costly when using such advanced and expensive instruments.

Moreover, these capillaries can be extremely brittle, so any slight contact with the capillary can cause imperfections.

### SUMMARY

One aspect provides an electrospray emitter assembly, e.g., for attachment to a mass spectrometer, the assembly comprising an emitter needle, a sheath and a housing configured for attachment to a mass spectrometer, wherein the sheath is arranged to shield the electrospray emitter needle, e.g., when not in use and/or when not attached to a mass spectrometer.

Thus, an assembly is provided in which the needle is protected before, and/or during and/or after its use.

In some cases, the sheath is operable to reveal, in use, the electrospray emitter needle, for example the assembly may be configured to operate the sheath to reveal the needle upon attachment and/or insertion of the assembly to and/or into a mass spectrometer. In some embodiments, the sheath is movable relative to the housing between a deployed position, e.g., in which the emitter needle is shielded, and a retracted position, e.g., in which the emitter needle is revealed for use.

Additionally or alternatively, the sheath may be movably adjustable relative to the housing between a plurality of different positions and/or the movement of the sheath relative to the housing may be carried out using a servo mechanism.

In another aspect there is provided an electrospray emitter assembly suitable for attachment to a mass spectrometer having an electrospray emitter needle and a housing wherein the housing is arranged to integrally clip onto a mass spectrometer.

The instrument may cooperate with the assembly to operate the sheath to reveal the electrospray emitter needle upon attachment and/or insertion of the assembly to and/or into the mass spectrometer.

According to another aspect, there is provided an electrospray emitter assembly suitable for attachment to a mass spectrometer source comprising an electrospray emitter needle and a housing, said housing configured for attaching the emitter assembly to a mass spectrometer and the housing further comprising a sheath arranged to shield the electrospray emitter needle, e.g., when the needle is not in use and/or when the assembly is not attached to the mass spectrometer source.

The assembly could be a single integral structure and/or may be designed and arranged to attach to a ‘clip’ attachment on the mass spectrometer. The housing may be arranged to integrally clip onto a mass spectrometer.

In some implementations, the housing or sheath is arranged to allow a gas flow into the mass spectrometer source region, e.g., upon attachment and/or upon retraction of the sheath and/or upon deployment of the needle. In some cases, the housing or sheath is arranged to be adjustable to allow the gas flows to be optimised. The optimization of the gas flows can be performed by a servo loop mechanism.

The electrospray emitter assembly can include an emitter needle attachment means to attach the emitter needle to a liquid chromatography system up stream of the electrospray emitter assembly

In a yet further aspect there is provided a connector assembly suitable for connecting a liquid chromatography system to an electrospray source of a mass spectrometer, the liquid chromatography system having an outlet and the mass spectrometer having an inlet, said connector assembly having an input connection to attach to the outlet of the liquid chromatography system and an output connection for connecting into the mass spectrometer wherein the connector is integrally formed

The output connection may comprise an electrospray emitter and/or housing, e.g., wherein the housing may comprise a sheath. In some implementations, the output connection comprises an electrospray emitter assembly according to the aspects aspects.

Yet another aspect provides a mass spectrometer supply assembly suitable for attachment to a mass spectrometer source comprising an injection needle and a housing, the housing configured for attaching the supply assembly to a mass spectrometer and the housing further comprising a sheath arranged to shield the injecting needle, e.g., when the needle is not in use and/or when the assembly is not attached to the mass spectrometer source.

Another aspect provides an interface device, e.g., for connecting a liquid chromatograph to a mass spectrometer, wherein the interface device may comprise an electrospray emitter assembly as described above, which may be fluidly connected to a liquid chromatograph connector, for example by tubing.

A yet further aspect provides a method of connecting an electrospray emitter assembly, e.g., as described above, to a mass spectrometer. The method may comprise the steps of attaching the or a housing of the assembly to the mass spectrometer and/or removing or retracting a sheath of the assembly, e.g., to reveal an electrospray emitter needle of the assembly.

Further aspects provide a control system operative or programmed to execute the removing or retracting step, an analytical instrument comprising a liquid chromatograph connected to a mass spectrometer by an interface device as described above and/or comprising the control system, a computer program element comprising computer readable program code for causing a processor to execute a procedure to implement the removing or retracting step, computer readable medium embodying such a computer program element and/or a computer readable medium having a program stored thereon which program is to make a computer execute a procedure to implement the removing or retracting step.

Implementations can provide one or more of the following advantages.

In some implementations, an assembly and/or an apparatus is provided in which the capillary is protected.

In certain implementations, an apparatus is provided that allows the easier replacement of the connector assemblies, and/or provides a more durable assembly.

Other aspects, features, and advantages are in the description, drawings, and claims.

### BRIEF DESCRIPTION OF THE DRAWINGS

FIG. 1 is a schematic of an LC-MS interface device that includes an electrospray emitter assembly according to one embodiment of the invention; and

FIG. 2 is a schematic of the electrospray emitter assembly of FIG. 1 connected to a mass spectrometer.

Like reference numbers indicate like elements.

### DETAILED DESCRIPTION

Referring to the Figures, there is shown an interface device 1 for use in an analytical instrument to connect the output of a liquid chromatograph (LC—not shown) to the inlet of an electrospray ion source of a mass spectrometer 10. The interface device 1 includes an LC connector 2, connection tubing 3 and an electrospray emitter assembly 4.

The LC connector 2 includes a cylindrical body 20 with an axial hole therethrough and an outwardly extending disc shaped flange 21 at one of its ends. A first end of the connection tubing 3 is received within the hole of the cylindrical body 20 and extends out of the other end of the LC connector 2.

The electrospray emitter assembly 4 includes an emitter needle 40 fluidly connected to the connection tubing 3, a housing 5, and a sheath 6. The housing 5 includes a hollow cylindrical portion 50 defining a chamber 51, a nozzle 52, and gas inlet 53 both on the lower side of the cylindrical portion 50, an analyte inlet 54 on the upper side of the cylindrical portion 50, and an attachment flange 55 extending from the circumference of the lower side of the cylindrical portion 50.

The nozzle 52 extends axially from the center of the lower side of the cylindrical portion 50 and is tubular with an enlarged head portion 56 having a groove 57 with an O-ring seal 58 received therein. The gas inlet 53 is an orifice through the lower wall of the cylindrical portion 50 that is offset from the nozzle 52. The analyte inlet 54 receives a second end of the connection tubing 3 and is sealed therewith by a seal 59 in the form of a hollow elastomeric plug through which the connection tubing 3 extends.

The sheath 6 includes a hollow cylindrical body portion 60 with an inwardly extending flange 61 at one of its ends and a nebulizer portion 62 having a reduced diameter extending from its other end, thereby creating a circumferential step 63. The nebulizer portion 62 also includes an inwardly extending flange 64 at its free end that defines an opening through which the emitter needle 40 extends in use. The sheath 6 slidingly receives the head portion 56 of the nozzle 52 so as to allow reciprocating movement of the sheath 6 relative to the nozzle 52 to reveal progressively more or less of the emitter needle 40. The chamber 51 is in fluid communication with the sheath 6 via the nozzle 52, while the O-ring seal 58 maintains a fluidic seal as the sheath 6 reciprocates along the nozzle 52.

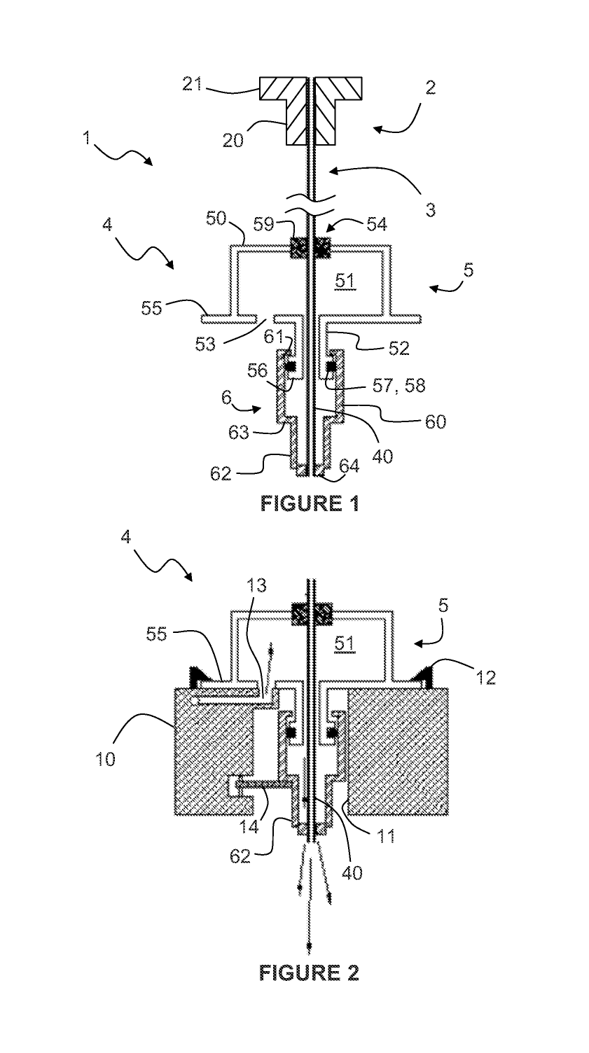

FIG. 1 shows the electrospray emitter assembly 4 in its transportation state, wherein the sheath 6 is in a fully deployed position such that the emitter needle 40 is covered completely to protect the emitter needle 40 from accidental damage. The sheath 6 is preferably secured in and/or biased toward the fully deployed state by securing and/or biasing means (not shown).

In use and with reference to FIG. 2, the electrospray emitter assembly 4 is mounted to the mass spectrometer 10 by first inserting the sheath 6 and nozzle 52 into an inlet 11 of the mass spectrometer 10 and securing them together by a quick release clamping mechanism 12 that clamps portions of the attachment flange 55. The electrospray emitter assembly 4 also incorporates locating means (not shown) for ensuring proper location between the gas inlet 53 and a gas outlet 13 of the mass spectrometer 10. Thus, gas is able to flow into the source region of the mass spectrometer 10 through the housing 5 and sheath 6.

On insertion of the sheath 6 into the inlet 11, an adjusting element 14 of the mass spectrometer 10 engages the sheath 6 and abuts the step 63. The adjusting element 14 is operated by a servo loop mechanism (not shown) to retract the sheath 6 and reveal the emitter needle 40 for use. It will be appreciated by those skilled in the art that the mass spectrometer 10 or the electrospray emitter assembly 4 may be configured to retract the sheath 6 automatically, for example by a mechanism that is activated on clamping by the clamping mechanism 12.

The mass spectrometer 10 control system is preferably configured to optimize the gas flow into the source by adjusting the sheath 6.

Thus the interface device 1 provides a simple yet effective means by which the electrospray emitter needle 40 is protected before, and/or during and/or after its use. This arrangement is particularly useful where the interface device 1 or electrospray emitter assembly 4 is provided as a pre-assembled unit separate from the analytical instrument. For example, this arrangement facilitates the provision of a disposable interface device 1.

It will be appreciated by those skilled in the art that several variations are envisaged without departing from the scope of the invention. For example, the sheath 6 could be removable rather than retractable. The clamping mechanism 12 may be replaced with any suitable arrangement, for example a clip arrangement.

It will also be appreciated by those skilled in the art that any number of combinations of the aforementioned features and/or those shown in the appended drawings provide clear advantages over the prior art and are therefore within the scope of the invention described herein.

Accordingly, other implementations are within the scope of the following claims.

What is claimed is:

1. An electrospray emitter assembly comprising:
an emitter needle;
a sheath; and
a housing configured for attachment to a mass spectrometer,
wherein the sheath is arranged to shield the electrospray emitter needle when the assembly is not attached to a mass spectrometer.

2. The assembly according to claim 1, wherein the sheath is operable to reveal, in use, the electrospray emitter needle.

3. The assembly according to claim 2, wherein the assembly is configured such that the sheath reveals the electrospray emitter needle upon attachment of the assembly to a mass spectrometer.

4. The assembly according to claim 2, wherein the sheath is movable relative to the housing between a deployed position in which the emitter needle is shielded and a retracted position in which the emitter needle is revealed for use.

5. The assembly according to claim 4, wherein the sheath is movably adjustable relative to the housing between a plurality of different positions.

6. The assembly according to claim 2, wherein the movement of the sheath relative to the housing is carried out using a servo mechanism.

7. The assembly according to claim 1, wherein said assembly is a single integral structure.

8. The assembly according to claim 1, wherein the housing comprises a flange for attachment to a mass spectrometer.

9. An interface device for connecting a liquid chromatograph to a mass spectrometer, the interface device comprising an electrospray emitter assembly according to claim 1 fluidly connected to a liquid chromatograph connector by tubing.

10. A method of connecting an electrospray emitter assembly to a mass spectrometer, the method comprising the steps of attaching a housing of the assembly to the mass spectrometer and removing or retracting a sheath of the assembly to reveal an electrospray emitter needle of the assembly.

11. A control system operative or programmed to execute the removing or retracting step of the method according to claim 10.

12. An analytical instrument comprising a liquid chromatograph connected to a mass spectrometer by an interface device according to claim 9.

13. The analytical instrument according to claim 12, wherein the instrument cooperates with the assembly to operate the sheath to reveal the electrospray emitter needle upon attachment of the assembly to the mass spectrometer.

14. A computer program element comprising computer readable program code means for causing a processor to execute a procedure to implement the removing or retracting step of the method according to claim 10.

15. A computer readable medium having a program stored thereon, where the program is to make a computer execute a procedure to implement the removing or retracting step of a method according to claim 10.
